(19) United States
(12) Patent Application Publication
(10) Pub. No.: US 2026/0365579 A1
(43) Pub. Date: Nov. 19, 2026

(54) ULTRA–HIGH PERFORMANCE CONCRETES WITH REINFORCED FLEXURAL STRENGTH

(71) Applicant: Amrize Technology Switzerland LLC, Zug (CH)

(72) Inventors: Olivier Halin, Saint Quentin Fallavier (FR); Emmanuel Bonnet, Saint Quentin Fallavier (FR); Jean-Nicolas Rivoal, Saint Quentin Fallavier (FR)

(73) Assignee: Amrize Technology Switzerland LLC, Zug (CH)

(21) Appl. No.: 19/144,240

(22) PCT Filed: Dec. 27, 2023
(86) PCT No.: PCT/EP2023/087853

§ 371 Date: Jun. 27, 2025

(30) Foreign Application Priority Data
Dec. 28, 2022 (EP) 22307056.6

(51) Int. Cl. C04B 28/04; C04B 14/04; C04B 14/06; C04B 14/22; C04B 14/48; C04B 16/00; C04B 103/32; C04B 103/50; C04B 111/00

(52) U.S. Cl. CPC C04B 28/04; C04B 14/041; C04B 14/06; C04B 14/22; C04B 14/48; C04B 16/00; C04B 2103/32; C04B 2103/50; C04B 2111/00155

(57) ABSTRACT

A hydraulic binder including as percentage by mass from 40% to 80% of a Portland cement, from 3% to 25% of silica fume, from 5% to 30% of a filler A1 selected from crushed glass, milled E-glass, ground feldspar filler, or mixtures thereof, from 0% to 25% of a filler A2 selected from siliceous mineral addition or limestone addition, the sum of these percentages being comprised from 80% to 100%. A mixture including the hydraulic binder and sand as well as to a hydraulic composition including the hydraulic binder. The hydraulic composition can be used in the construction field.

### FIELD OF THE INVENTION

The invention relates to hydraulic binders which give the possibility of obtaining an ultra-high performance concrete with reinforced flexural strength, and to mixtures comprising this binder.

### TECHNOLOGICAL BACKGROUND

Existing ultra-high performance concrete (UHPC) compositions are obtained by making use of the concept of optimized particle packing at the scale of fine elements and optimized water cement ratios. Ultrafine limestone filler and silica fume are commonly used to achieve the preferable packing properties, and the desired concrete performance.

Such known UHPC compositions can achieve final compressive strengths values of above 130 MPa, or even 150 MPa, and can be used in a high number of applications.

However, such concrete compositions often have low flexural strength values, which can be a limiting factor for specific applications.

The object of the present invention is to provide a UHPC composition that provides a higher flexural strength.

This is achieved by substituting all or part of the limestone filler with crushed glass, milled E-glass, ground feldspar filler, or mixtures thereof.

### SUMMARY OF THE INVENTION

The invention is directed to a hydraulic binder comprising as percentage by mass:
from 40% to 80% of a cement;
from 3% to 25% of silica fume;
from 5% to 30% of a filler A1 selected from crushed glass, milled E-glass, ground feldspar filler, or mixtures thereof;
from 0% to 25% of a filler A2 selected from siliceous mineral addition or limestone addition;
the sum of these percentages being comprised from 80% to 100%.

Preferably, the cement has a Blaine specific surface area greater than or equal to 4 000 cm²/g.

The cement is preferably a CEM I, a CEM II or a CEM III cement.

Preferably, particles of filler A1 have a D50 comprised from 2 μm to 80 μm, preferably from 5 μm to 30 μm.

Preferably, particles of filler A2 have a D50 comprised from 1 μm to 150 μm, preferably from 5 μm to 50 μm.

The invention is also directed to a mixture comprising as percentage by volume, at least 45% of the hydraulic binder of the invention and at least 30% of sand, the sum of these percentages being comprised from 95% to 100%.

Preferably, the particles of the sand have a D50 of at least 200 μm, preferably is comprised from 200 μm to 3 mm.

The invention is also directed to a hydraulic composition comprising in a volume of 1 m³:
from 200 liters to 300 liters of water;
at least 700 liters of mixture according to claim 6 or 7;
   the sum of the volumes of these 2 components being comprised from 950 liters to 1,000 liters.

Preferably, the hydraulic composition further comprises a superplasticizer, an anti-foaming agent of mixtures thereof.

Preferably, the hydraulic composition further comprise mineral, organic or metal fibers, or a mixture thereof.

The invention is also directed to a method for producing a hydraulic composition according to the invention wherein the hydraulic binder of the invention, the sand, water and optionally the fibers, the superplasticizer and/or the anti-foaming agent are mixed.

The invention is also directed to an object formed for the construction field comprising the hydraulic composition according to the invention.

The invention is also directed to the use of the hydraulic composition according to the invention in the restauration and repair of infrastructure elements such as bridge decks, pillars, beams or dams.

The invention is also directed to the use of the hydraulic composition according to the invention for shotcrete applications, or sprayed concrete.

The invention is also directed to the use of filler A1 selected from crushed glass, milled E-glass, ground feldspar filler, or mixtures thereof in ultra-high performance concrete compositions for improving the flexural strength of the concrete.

An aim of the present invention is to improve flexural strength of ultra-high-performance concrete in relation to the compressive strength. The invention seeks to provide at least one of the determining advantages described hereafter.

Another advantage of the hydraulic compositions according to the invention lies in their rheology. In particular, the hydraulic compositions of the invention are pumpable and can also be self-leveling, meaning having the characteristic that the hydraulic composition spread over a rough surface settles on its own to a horizontal level, without the intervention of any professional or any specific tool.

Other advantages and features of the invention will become clearly apparent upon reading the description and the examples given as purely illustrations and not as limitations which will follow.

### DEFINITIONS

D90, also noted as D_{V}⁹⁰, corresponds to the 90^{th} centile of the volume distribution of particle sizes, i.e. 90% of the volume consists of particles for which the size is less than D90 and 10% with a size greater than D90.

D50, also noted as D_{V}⁵⁰, corresponds to the 50^{th} centile of the volume distribution of particle sizes, i.e. 50% of the volume consists of particles for which the size is less than D50 and 50% with a size greater than D50.

D10, also noted as D_{V}¹⁰, correspond to the 10^{th} centile of the volume distribution of particle sizes, i.e. 10% of the volume consists of particles for which the size is less than D10 and 90% with a size greater than D10.

D10 or D90 of a set of particles may generally be determined by laser grain size measurement for particles with a size of less than 800 μm, or by screening for particles with a size of more than 63 μm.

The BET specific surface area is a measurement of the actual total surface area of the particles, which takes into account the presence of reliefs, irregularities, surface or internal cavities, porosity.

### DETAILED DESCRIPTION

### Hydraulic Binder

The present invention proposes a hydraulic binder comprising as percentage by mass:
from 40% to 80% of a cement;
from 3% to 25% of silica fume;
from 5% to 30% of a filler A1 selected from crushed glass, milled E-glass, ground feldspar filler, or mixtures thereof;
from 0% to 25% of a limestone filler A2;
the sum of these percentages being comprised from 80% to 100%.

The percentages are expressed in a mass percentage based on the binder

### Cement

The hydraulic binder according to the invention comprises a cement comprising Portland clinker, also called Portland cement. The Portland cement in the sense of the invention is a cement that comprises a Portland clinker and usually a source of calcium sulfate.

Portland cements are typically those defined in the standard NF EN 197-1 as of April 2012, in the standard NF EN 197-5 of May 2021, and those described in the ASTM C150-12 standard.

The cement may for example be selected from CEM I, CEM II, CEM III, CEM IV, or CEM V cements as defined in the standard NF EN 197-1 as of April 2012, or be selected from a CEM II and a CEM VI of the standard NF EN 197-5 of May 2021. The cement is preferably a CEM I, a CEM II, or a CEM Ill.

Preferably, the cement suitable for use according to the present invention has a Blaine specific surface area is greater than or equal to 4 000 cm²/g, preferably greater than or equal to 5 000 cm²/g. The cement may have a Blaine specific surface area lower or equal to 9 000 cm²/g.

Preferably, the hydraulic binder according to the invention comprises from 40% to 80% of cement, more preferentially from 50% to 70% expressed in a mass percentage based on the binder.

### Silica Fume

The hydraulic binder according to the invention comprises silica fume.

Silica fume suitable according to the invention may be a by-product of metallurgy and of silicon production. Silica fume is generally formed with spherical particles comprising at least 85% by mass of amorphous silica.

Preferably, the silica fume used according to the present invention may be selected from among silica fumes according to the European standard NF EN 197-1 of April 2012 paragraph 5.2.7.

Preferably, the hydraulic binder according to the invention comprises from 5% to 50% of silica fume, more from preferably 5% to 40%, further preferably from 6% to 30%, even more preferably from 6% to 15%, expressed as percentage by mass relative to the binder.

### Filler A1

Surprisingly, the inventors found that using the filler A1 in a UHPC composition improves the flexural strength of the resulting UHPC concrete. The flexural strength can be increased while maintaining sufficient compressive strength. The use of filler A1 allows an increase of the flexural/compressive strength ratio of the final product.

Filler A1 is selected from crushed glass, milled E-glass, ground feldspar filler, or mixtures thereof.

Crushed glass is a waste material obtained from glass.

Milled E-glass is a waste material that is obtained from old glass fibers, used in the area of telecommunications.

Crushed glass and milled E glass are composed of amorphous silica. The components of the glass preferably comprise SiO₂ and Al₂O₃. The components of the glass preferably comprise SiO₂, Al₂O₃, CaO, MgO, B₂O₃, F₂, Na₂O, K₂Oand Fe₂O, advantageously in a content ranging from 90% to 100% by weight of the glass.

Preferably, particles of filler A1 have a D50 comprised from 2 μm to 80 μm, preferably from 5 μm to 30 μm.

Preferably, particles of crushed glass have a D50 from 2 μm to 80 μm, more preferably from 5 μm to 30 μm.

Preferably, particles of milled E glass have a D50 from 2 μm to 80 μm, more preferably from 5 μm to 30 μm.

Ground feldspar is micronized feldspar fillers that are processed from a low in free silica chemically inert Feldspar. Feldspar is an alumino silicate rock. It is advantageously characterized by a chemical structure of (Ba,Ca,Na,K,NH₄)(Al,B,Si)₄O₃.

Preferably, particles of ground feldspar have a D50 from 5 μm to 50 μm, more preferably from 5 μm to 20 μm.

Preferably, the hydraulic binder according to the invention comprises from 5% to 40% of filler A1, more preferably from 6% to 25%, expressed as percentage by mass relative to the binder.

### Limestone Filler A2

The hydraulic binder according to the invention may further comprise a filler A2. The filler A2 can be selected from among siliceous mineral additions, limestone additions, or mixtures thereof.

Mineral additions comprising calcium carbonate, e.g. limestone, are preferably as defined in the NF EN 197-1 standard, paragraph 5.2.6.

Preferably, filler A2 particles have a D50 comprised from 1 μm to 150 μm, preferably from 5 μm to 50 μm.

Preferably, the hydraulic binder according to the invention comprises from 0% to 25% of filler A2, more preferably from 0% to 20%, even more preferably from 0% to 10%, expressed as percentage by mass relative to the binder. Preferably, the hydraulic binder according to the invention comprises more than 0% of filler A2, expressed as percentage by mass relative to the binder. Preferably, the hydraulic binder according to the invention comprises from 1% to 25% of filler A2, more preferably from 2% to 20%, even more preferably from 3% to 10%, expressed as percentage by mass relative to the binder.

### Others

The cement, silica fume, filler A1 and optional filler A2 are the main components of the hydraulic binder. The sum of their content, expressed as percentage by mass relative to the binder, ranges from 80% to 100%, preferably from 85% to 100%, more preferably from 90% to 100%, even more preferably from 95% to 100%.

The hydraulic binder according to the invention may also comprise from 0% to 20%, expressed as percentage by mass relative to the binder, of pozzolanic materials (e.g. such as defined in European standard NF EN 197-1 of April 2012 paragraph 5.2.3), slags (e.g. such as defined in European standard NF EN 197-1 of April 2012 2001 paragraph 5.2.2), calcined shales (e.g. such as defined in European standard NF EN 197-1 of April 2012 paragraph 5.2.5), materials containing calcium carbonate, limestone for example (e.g. such as defined in European standard NF EN 197-1 of April 2012 paragraph 5.2.6), siliceous additions (e.g. such as defined in French standard NF P 18-509 of December 1998 paragraph 5), fly ashes (e.g. such as defined in European standard NF EN 197-1 of April 2012 paragraph 5.2.4) or mixtures thereof.

### Mixture Hydraulic Binder—Sand

Another object according to the invention is also a mixture comprising a volume percentage, of at least 45% of the hydraulic binder according to the invention and at least 30% of sand, the sum of these percentages being comprised from 95 to 100%.

The mixture according to the invention comprises a sand.

Preferably, the sand of the mixture according to the invention is a siliceous sand, a calcined bauxite sand, a siliceous limestone sand, a limestone sand or mixtures thereof.

The grain size of the sands is generally determined by screening.

Preferably, the mixture according to the invention comprises a sand the particles of which a D50 of at least 200 μm, preferably is comprised from 200 μm to 3 mm.

Preferably, the particles of sand have a D50 comprised from 200 μm to 1 mm, more preferably from 250 μm to 800 μm, even more preferably from 250 μm to 500 μm. Preferably, the particles of sand have a D10 comprised from 100 μm to 1 mm, more preferably from 150 μm to 400 μm.

Preferably, the particles of sand have a D90 of less than or equal to 5 mm, more preferably from 300 μm to 5 mm, more preferably from 350 μm to 1,000 μm, further preferably from 300 μm to 600 μm.

### Hydraulic Composition

Another object according to the invention is also a hydraulic composition comprising in a volume of 1 m³, comprises:
from 200 to 300 liters of water;
at least 700 liters of binder-sand mixture according to the invention;
the sum of the volumes of these 2 components being comprised from 950 to 1 000 liters.

### Water

As used herein, the term “water” used with regard to the hydraulic composition relates to the water added for mixing the hydraulic composition and the water of the admixtures, such as the water of liquid plasticizer.

Advantageously, the hydraulic composition comprises from 200 to 300 liters of water, more preferably from 220 to 260 liters of water per cubic meter of hydraulic composition.

According to an advantageous embodiment of the method for preparing hydraulic composition according to the invention, the amount of mixing water is from 200 L/m³ to 300 L/m³, preferably from 220 L/m³ to 260 L/m³.

### Admixtures

The hydraulic composition according to the invention may also comprise at least an admixture, for example one of those described in the EN 934-2 standards as of September 2002, EN 934-3 standard as of November 2009 or EN 934-4 as of August 2009.

The hydraulic composition according to the invention may comprise an admixture for a hydraulic composition, for example an accelerator, a viscosity modifying agent, an anti-foam agent, a retarder, a clay inerting agent, a shrinkage-reducing agent, a plasticizer and/or a super-plasticizer.

It should be noted that these admixtures may be added to the binder or to the mixture or with to the hydraulic composition, generally with mixing water.

### Superplasticizer

In particular, the hydraulic composition may comprise a superplasticizer, in particular from 0.01% to 5%, preferably from 0.1% to 3%, a percentage expressed in dry extract mass based on the cement mass. The required amount of superplasticizer generally depends on the reactivity of the cement. The lower the reactivity, the smaller is the required amount of superplasticizer. In order to reduce the total amount of alkaline salts, the superplasticizer may be used as a calcium salt rather than as a sodium salt.

The term of “superplasticizer” herein is to be understood as including both water reducing agents and superplasticizers as described in the book entitled “Concrete Admixtures Handbook, Properties Science and Technology”, V.S. Ramachandran, Noyes Publications, 1984.

A water reducing agent is defined as an admixture which typically reduces the amount of mixing water by 10 to 15% typically of a concrete for a given workability. The water reducing agents include, for example lignosulfonates, hydroxycarboxylic acids, carbohydrates and other specialized organic compounds, e.g. glycerol, polyvinyl alcohol, sodium alumino-methyl-siliconate, sulfanilic acid and casein.

The superplasticizers are able to reduce the amounts of water by about 30%. Superplasticizers have been globally classified in four groups: sulfonated condensates of naphthalene formaldehyde (SNF) (generally a sodium salt); sulfonate condensates of melamine formaldehyde (SMF); modified lignosulfonates (MLS); and others. Superplasticizers also include polycarboxylic compounds such as polycarboxylates, e.g. polyacrylates. A superplasticizer is preferably of the polycarboxylate type, e.g. a copolymer containing a polyethylene glycol as a grafted chain and carboxylic functions in the main chain like a polycarboxylic ether. Sodium polycarboxylates-polysulfonates and sodium polyacrylates may also be used. The derivatives of phosphonic acid may also be used.

### Anti-Foam Agent

The hydraulic composition may further comprise an anti-foam agent, for example polydimethylsiloxane. Examples of anti-foam agents also comprise silicones as a solution, solid or preferably as a resin, an oil or an emulsion, preferably in water. Silicones comprising groups (RSiO_{0.5}) and (R₂SiO) are most particularly suitable. In these formulae, the radicals R, which may either be identical or different, are preferably a hydrogen atom or an alkyl group with 1 to 8 carbon atoms, the methyl group being preferred. The number of units is preferably from 30 to 120.

### Viscosifying Agent

The hydraulic composition may further comprise a viscosifying agent and/or an agent for modifying the flow limit (generally for increasing viscosity and/or flow limit). Such agents comprise: starch and starch derivatives; plant proteins; derivatives of cellulose, for example cellulose ethers soluble in water, such as sodium carboxymethyl, methyl, ethyl, hydroxyethyl and hydroxypropyl ethers; alginates; latex; polyether(polyethylene glycol); polyacrylamide; polyvinyl alcohol; and xanthan, carrageenan or guar gum. A mixture of these agents may be used.

Accelerator and/or a Retarder

The hydraulic composition according to the invention may further comprise an accelerator and/or a retarder.

### Fibers

The hydraulic composition according to the invention may further comprise fibers, for example mineral fibers (e.g. glass, basalt), organic fibers (e.g. plastic of APV type), metal fibers (e.g. steel) or a mixture thereof.

The organic fibers may notably be selected from among polyvinyl alcohol (PVA) fibers, poly-acrylonitrile (PAN) fibers, high density polyethylene (HDPE) fibers, polyamide or polyimide fibers, polypropylene fibers, aramid fibers or carbon fibers. Mixtures of these fibers may also be used.

These organic fibers may appear as an object either consisting of single strand or multiple strands, the diameter of the object ranging from 25 microns to 800 microns. The individual length of the organic fibers is preferably comprised between 10 mm and 50 mm.

As for metal fibers, these may be metal fibers selected from among steel fibers such as high mechanical strength steel fibers, amorphous steel fibers, or further stainless steel fibers. Optionally, the steel fibers may be coated with a non-ferrous metal such as copper, zinc, nickel (or their alloys).

The individual length of the metal fibers is preferably of at least 2 mm and is, even more preferentially, comprised in the range from 10 mm to 30 mm.

Fibers which are notched, corrugated or hooked-up at the ends may be used.

Preferably, the amount of fibers is comprised from 0% to 6%, even more preferentially from 0% to 5% of the volume of the hydraulic composition. Preferably, the amount of fibers is 0% of the volume of the hydraulic composition.

It should be noted that the fibers may be added to the binder or to the mixture according to the invention.

### Reinforcement Agents

The hydraulic composition may be reinforced, for example with metal bars, to produce formed objects. The hydraulic composition may be pre-stressed, by cables or adherent tendons, or post-tensioned, with cables or tendons or sheets or non-adherent bars.

The use of filler A1 in UHPC composition however allows reducing the quantity of reinforcement agents used.

### Properties

Advantageously, the hydraulic composition of the invention has a compression strength (Rc) greater than or equal to 130 MPa at 28 days.

Advantageously, the hydraulic composition of the invention satisfies at least one of the following properties, preferably all these properties:
without fibers:
   average value of the tensile strength (fctm.el) greater than or equal to 10.5 MPa at 28 days, preferably greater than or equal to 11 MPa at 28 days;
   average value of the flexural tensile strength (fcmt.fl) greater than or equal to 16 MPa at 28 days, preferably greater than or equal to 18 MPa at 28 days
with fibers:
   average value of the tensile strength (fctm.el) greater than or equal to 7 MPa at 28 days, preferably greater than or equal to 8 MPa at 28 days;
   average value of the flexural tensile strength (fcmt.fl) greater than or equal to 10 MPa at 28 days, preferably greater than or equal to 12 MPa at 28 days.

The hydraulic composition of the invention has an increased of the flexural/compressive strength ratio.

In particular, the hydraulic composition which does not comprise fibers of the invention satisfies at least one of the following properties, preferably all these properties:
the value for the ratio fctm.el/Rc is above 0.05, preferably above 0.07;
the value for the ratio fcmt.fl/Rc is above 0.01, preferably above 0.11.

In particular, the hydraulic composition which comprises fibers of the invention satisfies at least one of the following properties, preferably all these properties:
the value for the ratio fctm.el/Rc is above 0.03, preferably above 0.04;
the value for the ratio fcmt.fl/Rc is above 0.05, preferably above 0.06.

In addition, the hydraulic composition of the invention has the following advantages:
it is pumpable;
it may be applied by projection, in particular with a projection gun or by spraying with a projecting lance;
it may be used in methods for manufacturing concrete parts by calendering;
it may be used in repairing or rehabilitating concrete structures existing on inclined or vertical surfaces, for example a pier or bridge slab, or an unloading dock of a harbor;
it preferably has a stress threshold greater than 50 Pa measured at a shear gradient of 0.1 s⁻¹, more preferably greater than 100 Pa.

### Method for Producing the Hydraulic Composition

The hydraulic composition according to the invention may be prepared by mixing the mixture according to the invention or the hydraulic binder according to the invention with water.

Another aspect of the invention relates to a method for producing a hydraulic composition according to the invention wherein the hydraulic binder as defined above, the sand, water and optionally the fibers, admixtures as defined above are mixed.

When one or more admixtures are liquid, the method advantageously comprises:
mixing the hydraulic binder, the sand, and optionally admixtures described above except the liquid admixture(s);
add water and then add the liquid admixture(s).

When fibers are used, these are preferably added after the liquid admixture(s).

The mixing of the hydraulic composition may be conducted using known methods. The hydraulic composition according to the invention may be prepared according to methods known to one skilled in the art, comprising the mixing of solid components and water, shaping (for example, casting, projection, spraying or calendaring) and hardening.

For example, the method of producing a hydraulic composition according to the invention may advantageously comprise the following steps:
a) providing a hydraulic binder according to the invention;
b) mixing the hydraulic binder of step a) with water, for example at a speed kneading of from 20 to 35 rpm, until homogenization;
c) optionally, add liquid admixtures such as superplasticizer or defoaming agent, and/or add fibers while maintaining mixing, for example at a speed kneading of from 35 to 50 rpm, until homogenization.

Steps b) and c) can be concomitant. When fibers are used, these are preferably not added in step c), but in a subsequent step d) comprising adding the fibers to the mix obtained in step b) or step c) while maintaining mixing, preferably at a speed kneading of from 10 to 20 rpm.

As used herein the term “rpm” means “rotations per minute”.

### Uses

The hydraulic composition of the invention may be used directly in the fresh state at the work site and applied to an infrastructure element such a civil engineering structure or a building to be restored, or at a precast factory, or used as a coating on a solid support. Another aspect of the invention relates to an object formed for the field of construction comprising the hydraulic composition according to the invention.

The present invention also relates to a method for manufacturing an object for the field of construction comprising the following steps:
(i) preparing a hydraulic composition according to the invention;
(ii) applying the composition prepared at step (i) to a support.

Preferably, the method of the invention to manufacture an object further comprises a mould release step (iii) after hardening of the hydraulic composition, in particular if the support at step (ii) is a mould.

Preferably, the method of the invention to manufacture an object further comprises a step to pump the hydraulic composition after step (i).

Preferably, the support at step (ii) is a mould, a wall, a partition or a floor.

It may also be envisaged to spray the hydraulic composition by providing pneumatic, mechanical energy e.g. under pressure using a piston. Continuous spraying of compressed air onto the hydraulic composition can also be contemplated.

Preferably, step (ii) can be a projection step conducted using:
a positive displacement pump e.g. a piston pump, membrane pump, gear pump, vane pump, eccentric screw pump; or
a dynamic pump e.g. a centrifugal pump, vortex pump.

Another aspect of the invention relates to the use of a hydraulic composition according to the invention in the restauration and repair of infrastructure elements such as bridge decks, pillars, beams or dams.

Another aspect of the invention relates to the use of a hydraulic composition according to the invention for shotcrete applications, or sprayed concrete.

Another aspect of the invention relates to the use of filler A1 selected from crushed glass, milled E-glass, ground feldspar filler, or mixtures thereof in ultra-high performance (UHPC) concrete compositions for improving the flexural strength of the concrete.

The filler A1 is preferably as defined above.

The UHPC composition is preferably as defined above.

Another aspect of the invention relates to a method for improving the flexural strength of a concrete composition, wherein a filler A1 selected from crushed glass, milled E-glass, ground feldspar filler, or mixtures thereof is added to a hydraulic binder comprising cement and silica fume. The hydraulic binder composition is preferably as disclosed above. Preferably, the content of A2 filler in the hydraulic binder is strictly above 0% by weight.

### Measurement Methods

The following measurement methods were used:

### Laser Grain Size Measurement Method

The grain size curves of the different powders are obtained with a laser Malvern MS2000 granulometer. The measurement is carried out in a suitable medium (for example, in an aqueous medium); the size of the particles should be comprised from 0.02 μm to 2 mm. The light source consists of a red He—Ne laser (632 nm) and a blue diode (466 nm). The optical model is the Fraunhofer one, the computation matrix is of the polydisperse type. A measurement of background noise is first of all carried out with a pump rate of 2,000 rpm, a stirring rate of 800 rpm and a measurement of noise over 10 s, in the absence of ultrasonic waves. It is then checked that the light intensity of the laser is at least equal to 80%, and that a decreasing exponential curve is obtained for the background noise. If this is not the case, the lenses of the cell have to be cleaned.

A first measurement is then carried out on the sample with the following parameters: pump rate of 2,000 rpm, stirring rate of 800 rpm, absence of ultrasonic waves, obscuration limit between 10 and 20%. The sample is introduced in order to have an obscuration slightly greater than 10%. After stabilization of the obscuration, the measurement is carried out with a duration between the immersion and the measurement set to 10 s. The measurement duration is of 30 s (30,000 analyzed diffraction images). In the obtained granulogram, the fact that a portion of the population of the powder may be agglomerated should be taken into account.

Next a second measurement (without emptying the tank) is then carried out with ultrasonic waves. The pump rate is brought to 2,500 rpm, the stirring to 1,000 rpm, the ultrasonic waves are 100% emitted (30 Watts). This rate is maintained for 3 minutes, and then one returns to the initial parameters: pump rate 2,000 rpm, stirrer rate of 800 rpm, absence of ultrasonic waves. After 10 s (for removing the possible air bubbles), a measurement is made for 30 s (30,000 analyzed images). This second measurement corresponds to a powder de-agglomerated by ultrasonic dispersion.

Each measurement is repeated least twice in order to check the stability of the result. The apparatus is calibrated before each working session by means of a standard sample (silica C10 Sifraco) the grain size curve of which is known. All the measurements shown in the description and the announced ranges correspond to the values obtained with ultrasonic waves.

### BET Specific Surface Area Measurement Method

The specific surface area of the various powders is measured as follows. A powder sample is taken with the following mass: 0.1 to 0.2 g for an estimated specific surface area of more than 30 m²/g; 0.3 g for an estimated specific surface area of 10-30 m²/g; 1 g for an estimated specific surface area of 3-10 m²/g; 1.5 g for an estimated specific surface area of 2-3 m²/g; 2 g for an estimated specific surface area of 1.5-2 m²/g; 3 g for an estimated specific surface area of 1-1.5 m²/g.

A 3 cm³ or 9 cm³ cell is used depending on the volume of the sample. The whole of the measurement cell (cell+glass rod) is weighed. Next the sample is added into the cell: the product should not be at less than one millimeter from the top of the neck of the cell.

The whole (cell+glass rod+sample) is weighed. The measurement cell is set into place on a degassing station and the sample is degassed. The degassing parameters are 30 min/45 °C for Portland cement, gypsum, pozzolans; 3 h/200 °C for slags, flying ashes, aluminous cement, limestone; and 4 h/300 °C for controlled alumina. The cell is rapidly blocked with a plug after degassing. The whole is weighed and the result is noted. All the weighing operations are carried out without the plug, the latter being temporarily removed for making the measurement. The mass of the sample is obtained by subtracting the mass of the cell from the sum of the masses of the cell and of the degassed sample.

Next analysis of the sample is carried out after having set it into place on the measurement station. The analyser is the SA 3100 from Beckman Coulter. The measurement is based on the adsorption of nitrogen by the sample at a given temperature, here the liquid nitrogen temperature i.e. about −196 °C. The apparatus measures the pressure of the reference cell in which the adsorbate is at its saturating vapor pressure and that of the cell of the sample into which known volumes of adsorbate are injected. The resulting curve from these measurements is the adsorption isotherm. In the measurement method, the knowledge of the dead volume of the cell is required: a measurement of this volume is therefore conducted with helium before the analysis. The sample mass computed earlier is entered as a parameter. The BET surface area is determined by the piece of software by linear regression from the experimental curve.

The reproducibility standard deviation obtained from 10 measurements on a silica with specific surface area of 21.4 m²/g is 0.07. The obtained reproducibility standard deviation from 10 measurements on a cement with specific surface area of 0.9 m²/g is 0.02. Once every two weeks, a check is carried out on a reference product. Twice a year, a check is conducted with the reference alumina provided by the manufacturer.

### Compressive Strength Measurement Method:

The compressional strength (Cs) is measured on cylindrical sample having a diameter of 7 cm and a height of 14 cm, the surfaces on which the compressive force is applied to the sample are flattened. Cylinder diameter of 70 mm×height 140 m were filled with concrete and tested according to the NF EN 12390-3 “Determination de la resistance en compression” (June 2019). The estimation of the characteristic value is done according to NF P 18-470 Annexe B (July 2016) using 6 experimental results. The applied compressive force is increased up to a level of 3.08 kN/s during the compression test.

### Flexural and Tensile Strength Measurement Method:

The flexural and tensile strengths is measured on prism sample having a width and height of 7 cm and a length of 28 cm. 7×7×28 cm prisms are filled with concrete and tested according to the NF P 18-470 “Annexe D Essais de flexion sur prismes et methode d'exploitation” (July 2016), using a three-point procedure.

Alternatively, samples can be cut from concrete blocks. This is the case for fiber samples resulting from a shotcrete process
fctm,el: average value of the tensile strength, expressed in MPa
fcmt,fl: average value of the flexural tensile strength, expressed in MPa

### Examples

The present invention is described by the following which are non-limiting.

### Raw Materials:

| | | |
|---|---|---|
| ✓ | Cement Le Teil | provided by Lafarge |
| ✓ | Limestone filler, Durcal 40 | provided by Omya |
| ✓ | Silica fume, FS Rima | provided by Rima |
| ✓ | Milled E-glass, G75 | provided by Sibelco |
| ✓ | Milled E-glass, G25 | provided by Sibelco |
| ✓ | Micronised feldspar filler, PGW 13 | provided by Sibelco |
| ✓ | Superplasticizer, polycarboxylate based | provided by Chryso |
| ✓ | Sand, BE01 | provided by Sibelco |

The limestone filler D40 has a D50 of 30 μm.

Milled E-glass, G75 has a D50 of 31 μm and D97 of 130 μm.

Milled E-glass, G25 has a D50 of 12 μm and D97 of 41 μm.

Micronised feldspar filler PGW 13 has a D50 of 13 μm and D97 of 60 μm.

BE01 sand is siliceous sand. It has a D10 of about 210 μm, a D50 of about 310 μm and, a D90 of about 400 μm.

Procedure 1 for Preparing the Hydraulic Compositions for Self-Leveling Material without Fibers:

The concrete (hydraulic composition) was manufactured according to the procedure described hereafter:
1) introduction of the dry materials (sand, cement, fillers) in the bowl of the Rayneri kneader;
2) kneading for 3 minutes at the rate of 15 revolutions per minute, for homogenizing the dry materials;
3) introduction of the mixing water and one half of the super-plasticizer over 30 seconds, at a rotation speed of 35 revolutions per minute;
4) kneading for 4 minutes and 30 seconds at a speed of 35 revolutions per minute;
5) introduction of the other half of superplasticizer over 30 seconds at a rotation speed of 50 revolutions per minute;
6) kneading for 2 minutes and 30 seconds at speed of 50 revolutions per minute;
7) stopping the kneader.

A fresh concrete was obtained. Cylinder diameter of 70 mm×height 140 m and prismatic specimen 7×7×28 cm were filled with concrete. All the specimens were demoulded at 1 day, stored à 100% relative humidity and 20 °C and tested after 28 days.

The mechanical strengths were then measured.

Procedure 2 for Preparing the Hydraulic Compositions for Shotcrete Material with Fibers:

The concrete (hydraulic composition) is prepared according to the procedure described hereafter:
1) introduction of the dry materials (sand, cement, fillers) in the concrete mixer
2) mixing for 1 minutes for homogeneization
3) introduction of the water and the superplasticizer
4) mixing for 5 minutes
5) introduction of the steel Fibers
6) mixing for 3 minutes

A fresh concrete was obtained and transferred into a piston concrete pump (Putzmeister P730). The concrete is pumped and sprayed using a spraying nozzle (betojet Putzmeister) and a air flow delivered by an air compressor XATS 156 D ATLAS COPCO 10 000 L/min settled at 7 bars.

Timber mold 50×50×15 cm are filled by sprayed concrete and demolded at 1 day, stored at 100% relative humidity and 20 °C. At 7 days, cylinder diameter of 70 mm×height 140 m are drilled and prismatic specimen 7×7×28 cm are cutted, stored 2 100% relative humidity and 20BC tested after 28 days.

The mechanical strengths were then measured.

### Example 1

A set of results on self-leveling concrete without fibers is presented. UHPC R1 and UHPC 1 are prepared according to procedure 1 described above. UHPC R1 is a comparative example: the binder comprises silica fume and limestone fillers only. UHPC 1 is a cement according to the invention: the limestone filler (filler A2) is substituted by glass (filler A1).

TABLE 1

| | |
|---|---|
| UHPC R1 | UHPC 1 |

composition (kg/m³)

| | | | |
|---|---|---|---|
| water | tap water | 243 | 242 |
| cement | HTS le Teil 52.5R | 759 | 757 |
| silica fume | Rima | 148 | 158 |
| Filler | Limestone, Durcal 40 | 213 | — |
| | Milled E glass, G75 | — | 212 |
| Sand | BE01 | 911 | 908 |
| Admixture | Superplasticizer | 8.1 | 7.5 |

Mechanical Properties

| | | |
|---|---|---|
| Cs Average (MPa) | 166 | 168 |
| Fctm, fl (MPa) | 17.1 | 19.5 |
| Fctm, el (MPa) | 10.5 | 11.9 |

UHPC concrete R1 has adequate compressive strength but flexural strength values are low. Substituting the limestone filler with milled E-glass increases flexural strength values while maintaining sufficient compressive strength.

### Example 2

A set of results on self-leveling concrete without fibers is presented. Two UHPC cements are prepared according to the procedure 1 described above. UHPC 2 is a cement according to the invention: part of the limestone filler (filler A2) is substituted by feldspar (filler A1). UHPC 3 is a cement according to the invention: part of the limestone filler (filler A2) is substituted by glass (filler A1).

TABLE 2

| | |
|---|---|
| UHPC 2 | UHPC 3 |

composition (kg/m³)

| | | | |
|---|---|---|---|
| water | tap water | 242 | 242 |
| cement | HTS le teil 52.5R | 690 | 690 |
| silica fume | Rima | 100 | 100 |
| Filler | Limestone, Durcal 40 | 200 | 200 |
| | Milled E glass, G25 | | 100 |
| | Micronised Feldspar, PGW13 | 100 | |
| Sand | BE01 | 936 | 936 |
| Admixture | Superplasticizer | 7.9 | 8.5 |

Mechanical Properties

| | | |
|---|---|---|
| Cs Average (MPa) | 153 | 155 |
| Fctm, fl (MPa) | 19.9 | 18.5 |
| Fctm, el (MPa) | 12.1 | 11.3 |

Substituting the limestone filler with milled E-glass or Micronized Feldspar increases flexural strength values while maintaining sufficient compressive strength.

### Example 3

A set of results on sprayed concrete with fibers is presented. Three UHPC cements are prepared according to the procedure 2 described above. UHPC R3 is a comparative example: the binder comprises silica fume and limestone fillers only. UHPC 4 and 5 are a cement according to the invention: the limestone filler (filler A2) is substituted by glass (filler A1). UHPC 4 and 5 presented two different fibers dosages attesting that the flexural and tensile strength improvement is carried by the filler A1.

TABLE 3

| | | |
|---|---|---|
| UHPC R3 | UHPC 4 | UHPC 5 |

composition (kg/m³)

| | | | | |
|---|---|---|---|---|
| water | tap water | 243 | 242 | 242 |
| cement | CEM I Le Teil 52.5R | 759 | 735 | 735 |
| silica fume | Rima | 148 | 143 | 143 |
| Filler | Limestone, Durcal 40 | 213 | 100 | 100 |
| | Milled E glass, G75 | | 206 | 206 |
| Sand | BE01 | 911 | 882 | 882 |
| Admixture | Superplasticizer | 8.1 | 11 | 11.6 |
| steel fibers | Dramix 14/0.2 | 156 | 156 | 253.5 |
| | steel fibers | | | |

Mechanical Properties

| | | | |
|---|---|---|---|
| Cs Average (MPa) | 175 | 191 | 213 |
| Fctm, fl (MPa) | 9 | 13 | 13.6 |
| Fctm, el (MPa) | 6 | 8.3 | 8.3 |

UHPC concretes 4 and 5 have both adequate compressive strength and flexural strength.

1. A hydraulic binder comprising as percentage by mass:
from 40% to 80% of a cement;
from 3% to 25% of silica fume;
from 5% to 30% of a filler A1 selected from crushed glass, milled E-glass, ground feldspar filler, or mixtures thereof;
from 0% to 25% of a filler A2 selected from siliceous mineral addition or limestone addition;
the sum of these percentages being comprised from 80% to 100%.

2. The hydraulic binder according to claim 1, wherein the cement has a Blaine specific surface area greater than or equal to 4,000 cm²/g.

3. The hydraulic binder according to claim 1, wherein the cement is a CEM I, a CEM II or a CEM III cement.

4. The hydraulic binder according to claim 1, wherein particles of filler A1 have a D50 comprised from 2 μm to 80 μm.

5. The hydraulic binder according to claim 1, wherein particles of filler A2 have a D50 comprised from 1 μm to 150 μm.

6. A mixture comprising as percentage by volume, at least 45% of the hydraulic binder according to claim 1 and at least 30% of sand, the sum of these percentages being comprised from 95% to 100%.

7. The mixture according to claim 6, wherein the particles of the sand have a D50 of at least 200 μm.

8. A hydraulic composition comprising in a volume of 1 m³:
from 200 liters to 300 liters of water; and
at least 700 liters of mixture according to claim 6;
the sum of the volumes of these 2 components being comprised from 950 liters to 1,000 liters.

9. The hydraulic composition according to claim 8, further comprising a superplasticizer, an anti-foaming agent of mixtures thereof.

10. The hydraulic composition according to claim 8, further comprising mineral, organic or metal fibers, or a mixture thereof.

11. A method for producing a hydraulic composition according to claim 8 wherein the hydraulic binder as defined in claim 1, the sand and water are mixed.

12. An object formed for the construction field comprising the hydraulic composition according to claim 8.

13. A method comprising restoration and repair of infrastructure elements with use of the hydraulic composition according to claim 8.

14. A method comprising shotcrete application, or sprayed concrete with the use of the hydraulic composition according to claim 8.

15. A method for improving the flexural strength of a concrete composition, wherein a filler A1 selected from crushed glass, milled E-glass, ground feldspar filler, or mixtures thereof is added to a hydraulic binder comprising cement and silica fume.
